(19) United States
(12) Patent Application Publication
(10) Pub. No.: US 2008/0272002 A1
(43) Pub. Date: Nov. 6, 2008

(54) System and Method for Proteomics

(75) Inventors: Jack Johansen, Concord, MA (US); Russell K. Garlick, Needham, MA (US); William Skea, Saco, ME (US); Stephen Haralampu, Belmont, MA (US); Oren Kagan, Chestnut Hill, MA (US)

Correspondence Address: PATREA L. PABST;PABST PATENT GROUP LLP, 400 COLONY SQUARE, SUITE 1200, 1201 PEACHTREE STREET, ATLANTA, GA, 30361, US

(73) Assignee: Protein Forest, Inc.

(21) Appl. No.: 11/744,060

(22) Filed: May 3, 2007

(51) Int. Cl. G01F 1/64

(52) U.S. Cl. 204/456

(57) ABSTRACT

Significantly higher yield and better resolution in pI gels are obtained by creating traps having two or more layers of gel containing closely stepped immobilized pH buffers. Proteins move from a pH at which they are negatively charged towards an anode at which they are positively charged. Discrete regions containing immobilized pH buffers trap the proteins when the immobilized buffer pH and the protein pI are approximately the same. The protein is trapped within the second layer and not on the surface of or interface of the second layer. Significantly higher yields with better resolution can be obtained through the use of layered sample application gels prior to isoelectric focusing. Layered plugs are prepared with a range of immobilized pH buffers ranging, for example, over 2 pH units, with steps of 0.05 or 0.1 pH units. An array of multilayered plugs wherein each plug has different pH increments is also provided. The array can be used to isolate and trap a variety of proteins having different isoelectric pHs during a single run. Another embodiment provides plugs having at least three layers; a gate layer, a trap layer, and an exit layer. Another embodiment includes adding a carrier ampholytes to running buffers and or adding thiol containing reducing agents to reduce current and improve resolution and collection efficiency.

### FIELD OF THE INVENTION

This application is generally in the field of systems, kits and components thereof, for use in a method of separation of biomolecules in complex samples, especially those present in relatively low quantities, in a rapid and repeatable manner.

### BACKGROUND OF THE INVENTION

Human plasma is rich in biomarkers, however, most biomarker proteins are undetected by current methods. This is because there are more than 3000 different plasma proteins and abundant proteins, such as albumin, mask low abundant disease biomarkers and thereby prevent detection. Successful biomarker discovery requires fractionation prior to mass spectroscopy analysis to “dive below the tip of the proteomics iceberg.”

Many products are available for separation of mixtures of biomolecules, such as high performance liquid chromatography (HPLC) and gel electrophoresis, including gels that separate by molecular weight, charge, and pH. Isoelectric focusing is when molecules are placed in a pH gradient or different discrete pHs, and an electrical field applied so that the molecules move to the pH at which the molecule is at neutral charge.

Electrophoresis is conventionally conducted on plates or slabs as in thin-layer chromatography. To maintain the ionic buffer solution on the plate, some anticonvective medium or gel is necessary, so the method is called slab-gel electrophoresis. Polyacrylamide or agarose is typically used as the gel material. Electrophoresis separates on the basis of charge. Size separation or sieving can also be important applications, where the pore dimensions of the gel are comparable to the dimensions of the biopolymers to be separated. The gel matrix resists migration of the substances in the electric field, and separation is based on the size of the molecules, with the smallest migrating the fastest. This principle is essential for the separation of DNA molecules, since these species cannot be electrophoretically separated without the porous gel matrix. An important application of this method is DNA sequencing in which the order of the four nucleotides (adenine, cytidine, guanine, and thymidine) in an oligonucleotide molecule must be determined. The method thus aids in the sequencing of the human genome. Proteins can also be electrophoretically separated by gel sieving. Typically, the protein is denatured and combined with an excess of detergent, such as sodium dodecyl sulfate (SDS). The resulting SDS-protein complexes have the same charge density and shape and are therefore resolved according to size in a gel matrix. This method is useful in characterizing proteins and evaluating their purity.

In addition to being separated by size, proteins can also be separated according to their overall charge. A particularly useful method based on this principle is isoelectric focusing (IEF). At a given pH of a solution, a specific protein will have equal positive and negative charges and will therefore not migrate in an electric field. This pH value is called the isoelectric point. A slab gel (or column) can be filled with a complex mixture of buffers (known as ampholytes) that, under the influence of an applied field, migrate to the position of their respective isoelectric points (“pI”) and then remain fixed. A pH gradient is established which then allows focusing of proteins at their respective isoelectric points. Charge (IEF) and size (SDS-protein complex) separations can be combined in a two-dimensional approach. Two-dimensional gel electrophoresis is one of the most powerful resolving methods now available. Additionally or alternatively, the proteins separated by pH can be further analyzed by mass spectrometry, tryptic digestion, other types of chromatography, and immunoseparations.

Protein Forest has developed a system for isoelectric focusing of extremely small samples, having very close differences in pI. The basis for its technology is described in U.S. Pat. No. 7,166,202. Proteins are quickly trapped at their pI in pH controlled gel plugs. Protein Forest's parallel fractionation technology platform differs from conventional IPG electrophoresis by allowing proteins access to the entire pH range in parallel until they become trapped. By creating controlled pH zones in the electrode chambers, proteins are forced to migrate toward the dPC™. When a protein encounters a gel plug at, or very near its pI, its migration stops. Proteins in gel plugs not at their pI traverse the dPC™ in a short period of time, enter the opposite electrode chamber, change charge due to the change in pH environment, and change direction and move toward the dPC™ again. Proteins continue to circulate through the dPC™ until the mixture is separated in each of the pI traps. Protein Forest's technology platform is highly specific, capable of segregating proteins in fractions less than 0.1 pH units apart. The dPC™ relies on a dynamic separation process.

Proteomics is the identification of proteins to determine their physiological and pathophysiological functions. Samples contain thousands of proteins which must be fractionated before analysis by another method, such as mass spectroscopy. Proteomics can involve up to 20 million samples that need to be analyzed. Methods must be able to separate intact proteins as well as peptide fragments. These are then characterized by mass spectroscopy followed by protein identification, cataloging and mapping. The bottleneck in the process is at the sample preparation stage, where protein losses, poor resolution and/or poor repeatability and low throughput greatly limit the process. Biomarker discovery requires high protein loads, abundant protein depletion and concentration of low abundant proteins prior to mass spectroscopy.

It is therefore an object of the present invention to provide an improved method and system for rapid and high throughput separations of samples for subsequent analysis.

### SUMMARY OF THE INVENTION

Significantly higher yield and better resolution in pI gels are obtained by creating traps having two or more layers of gel containing closely stepped immobilized pH buffers. Proteins move from a pH at which they are negatively charged towards an anode at which they are positively charged. Discrete regions containing immobilized pH buffers trap the proteins when the immobilized buffer pH and the protein pI are approximately the same. Higher yields are obtained using multilayer regions wherein the first layer contains a first pH, and a second adjacent layer contains a closely stepped immobilized pH buffer, for example, having a pH 0.05 units less than the pH of the first layer. This second layer acts as a trap while the first layer acts as a gate for the proteins. The trapped protein is trapped within the second layer and not on the surface of or interface of the second layer.

It has also been discovered that significantly higher yields with better resolution can be obtained through the use of layered sample application gels prior to isoelectric focusing. Layered plugs are prepared with a range of immobilized pH buffers ranging, for example, over 2 pH units, with steps of 0.05 or 0.1 pH units. As demonstrated by the example, the layered plugs yielded significantly larger detectable amounts of isolated proteins. This is particularly important in separations of biological fluids that contain hundreds or thousands of components, such as plasma or serum, or bacterial, cell or tissue lysate. It is also important in separations in which one is trying to determine the level of expression following administration of a drug or drug candidate, or characteristic of a disease or disorder, as compared to control levels of expression. An array of multilayered plugs wherein each plug has different pH increments is also provided. The array can be used to isolate and trap a variety of proteins having different isoelectric pHs during a single run.

Another embodiment provides plugs having at least three layers: a gate layer, a trap layer, and an exit layer. The gate layer interfaces with the cathode chamber on one side and the trap layer on the other side. The gate layer has a pH greater than the pH of the trap layer. Typically, the pH of the trap layer is from about 0.1 to about 0.05 lower than the pH of the gate layer. The exit layer interfaces with the anode chamber on one side and the trap layer on the other side. The exit layer has a pH greater than the trap layer, usually slightly above pH 7.0 to about pH 8.0.

Low conductivity buffers are preferred to increase resolution at high field strengths. It has been discovered that addition of a reducing agent such as dithiothreitol (“DTT”) and/or beta mercaptoethanol to the running buffer will enhance resolution and decrease conductivity, thereby decreasing the required current and limiting heat generation. Addition of a small amount of ampholytes to the buffer fills ion depletion zones between the running buffers and gel plugs further improves resolution and yield.

### BRIEF DESCRIPTION OF THE DRAWINGS

FIG. 1 is a schematic of a representative two-layer pI trap.

FIGS. 2A-2E are schematics of the construction of multilayered pH regions that serve as pI traps.

FIGS. 3A-3B are schematics of a dPC™ device and system. FIG. 3A depicts the proteome chip alone and inserted between anode and cathode buffer chambers. FIG. 3B shows the running buffer chamber that the chip/anode and cathode buffer assembly is inserted into. FIG. 3C show a vertical electrophoresis apparatus for running the gel.

FIGS. 4A and 4B are a side by side comparison of the separation achieved with the multi-layered pI traps (FIG. 4A) and with a single layer (FIG. 4B).

FIGS. 5A and 5B are photographs comparing proteome coverage of an E. coli lysate separation between pH 4.2 and 6.2 by dPC™ isoelectric focusing and SDS PAGE 4-20% gels second dimension. FIG. 5A is the separation of E. coli lysate without pharmalytes and DTT in running buffers. FIG. 5B shows the separation of E. coli lysate with 0.25% pharmalytes and 40 mM DTT in running buffers.

FIGS. 6A and 6B are photographs comparing staining intensities in a gel that was run with layered plugs (FIG. 5A) versus a gel that was run with conventional single gel plugs (FIG. 5B). pH ranges were 4.2 to 6.2 (+0.10)×2 layered chip. 20 microliters of E. coli cell lysate was mixed 1:1 with cathode buffer with sequential load. 7M urea/2M thiourea; 1.8% CHAPS; 1% TRITON X-100; 40 mM DTT buffers with 0.25% Pharmalytes (2.5-5) anode/(5-8) cathode. 30 min run time with 6 min voltage ramp to 300 V. 4-20% second dimension gel. SYPRO stain. 1.5 second exposure.

### DETAILED DESCRIPTION OF THE INVENTION

### I. Isoelectric Focusing System

A. Layered pI Traps

An isoelectric focusing system containing multi-layered isoelectric focusing (“IEF”) protein traps is provided (FIGS. 1A-1C) in the system of FIGS. 1D-1E. In a preferred embodiment, pI traps are prepared using two or more layers in abutment wherein the layers contain immobilized pH buffers with very small differential increments in pH between the layers. The pI traps are also referred to as “plugs”. The layers are typically formed by crosslinking a polymer. Suitable layers are gel layers as described more fully below.

Referring to FIG. 1 of a layered pI trap 10, proteins are initially applied in the cathode chamber 20, where the electrode is negative, and basic buffer added. The proteins become negatively charged. The proteins then move toward the positively charged anode chamber 22. The pI trap or plug 24 is positioned between the cathode and anode. The gel layer of the trap in contact with the cathode chamber is referred to as the “gate” layer 26. The second layer of the trap is referred to as the “trapping” layer 28 and is in contact with the gate layer 26 on one side and the anode chamber 22 on the other side. The traps are designed to capture or trap proteins having a pI within a defined range. The capture region is within the central region of the plug on the interface between the two different pH regions and not on the external surface of the plug. One should note, however, that the two-layer system is symmetric. Thus proteins can become trapped while migrating from the Anode chamber through the plugs and to the Cathode chamber.

The protein circulates and both directions are used to trap the protein. For example, a pI trap or plug can be designed to capture proteins having a pI in the range 5.15<pI<5.20. Such a pI trap would have a gate layer with a pH of 5.20 and a trapping layer having a pH of 5.15. A protein having a pI of 5.20 or greater would not enter the gate layer. A protein having a pI below 5.20 would be negatively charged and travel through the gate layer. If the protein has a pI below 5.15, it will travel through the trapping layer and out into the anode chamber. If the protein has pI above 5.15 it will change its charge, reverse direction and travel towards the gate layer where it will become negatively charged and move back towards the trapping layer, and thereby become trapped within the plug and not on the surface of the plug. If the protein has a pI equal to the pH of the gate layer, the protein will be captured on the surface of the gate layer or in the gate layer.

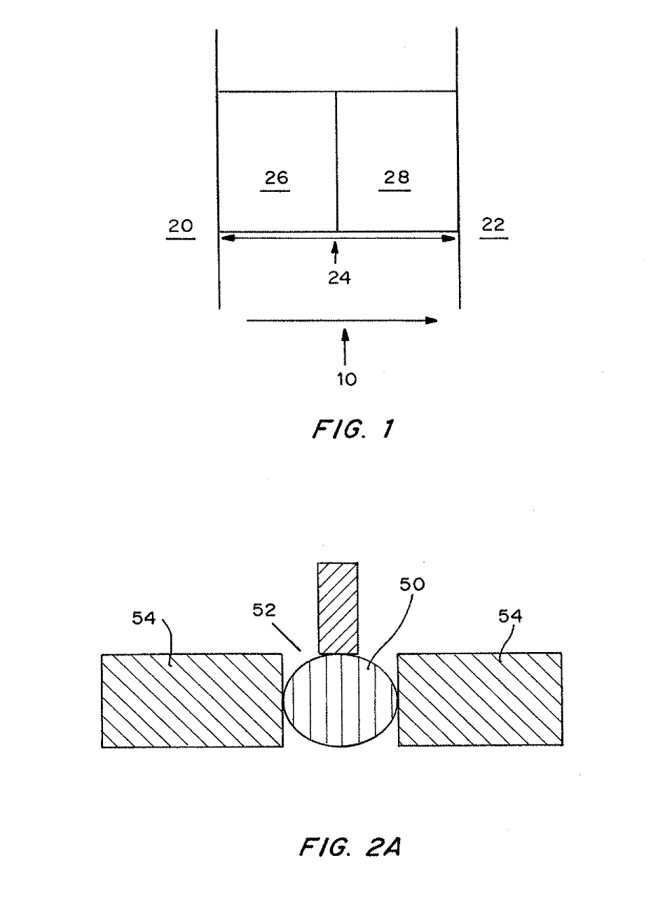

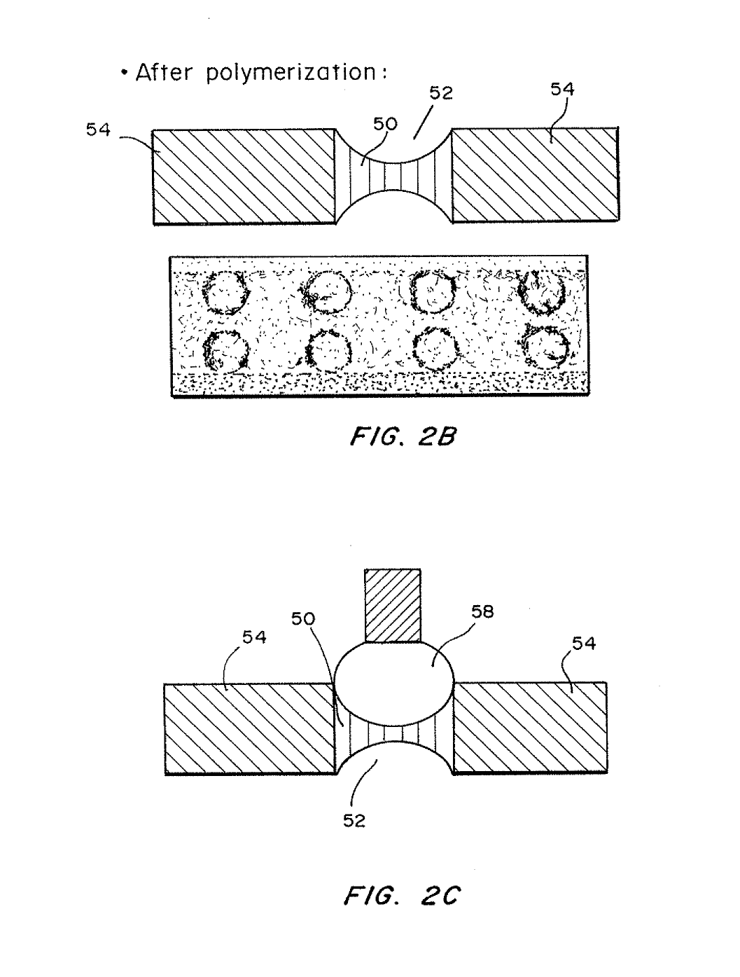

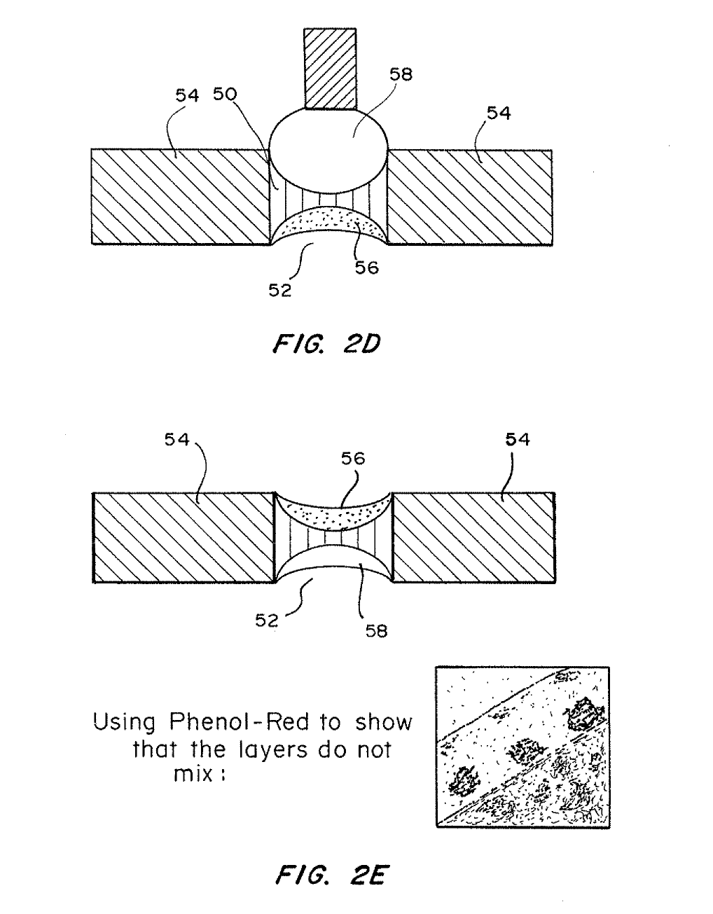

The pI traps can be produced using conventional methods. For example, holes can be bored through a substrate to produce the chip. In each hole, a first layer can be cast and allowed to polymerize fully or partially. The second layer can then be cast on top of the first layer. In one embodiment, a thin, neutral separation layer is cast in a hole and allowed to polymerize. The active layers are then cast above and below the neutral separation layer as shown in FIGS. 2A-2E.

Referring to FIG. 2A, the first layer 50 is cast in a plug hole 52 in the dPC 54. A 1.1 microliter separation layer 50 is cast on the first layer (6% acrylamide with 10% glycerol and 50% trehalose), which is then polymerized for 30 minutes using ultraviolet radiation. Referring to FIG. 2B, the result is a neutral separation gel layer 50 in the middle of the plug hole 52. Referring to FIG. 2C, a second layer 58 is cast from 0.8 microliters standard acrylamide-bisacrylamide (AHMS) containing immobiline buffers to control pH and photopolymerization initiators on top of the separation gel layer 50. This is polymerized for thirty minutes with ultraviolet radiation. FIG. 2D shows this layer 50 as a solid gel in the inverted gel 58. A second separation layer 56 is cast from 0.8 microliters standard acrylamide-bisacrylamide (ABMS) containing immobiline buffers to control pH with a slightly shifted pH and photopolymerization initiators, which is then polymerized for thirty minutes using ultraviolet light.

The completed gel is shown in FIG. 2E. This gel provides high collection efficiency and resolution.

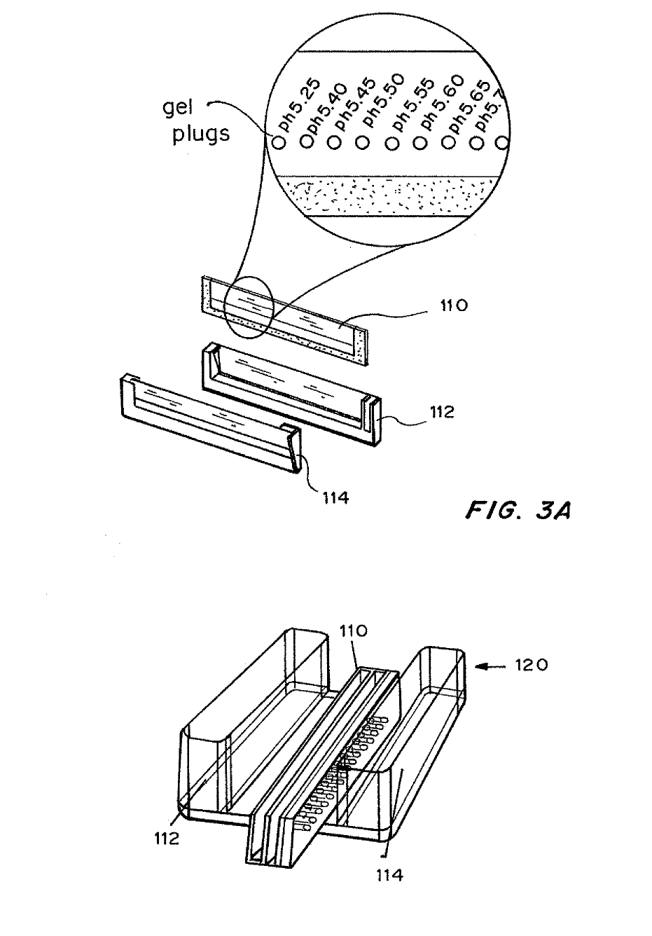

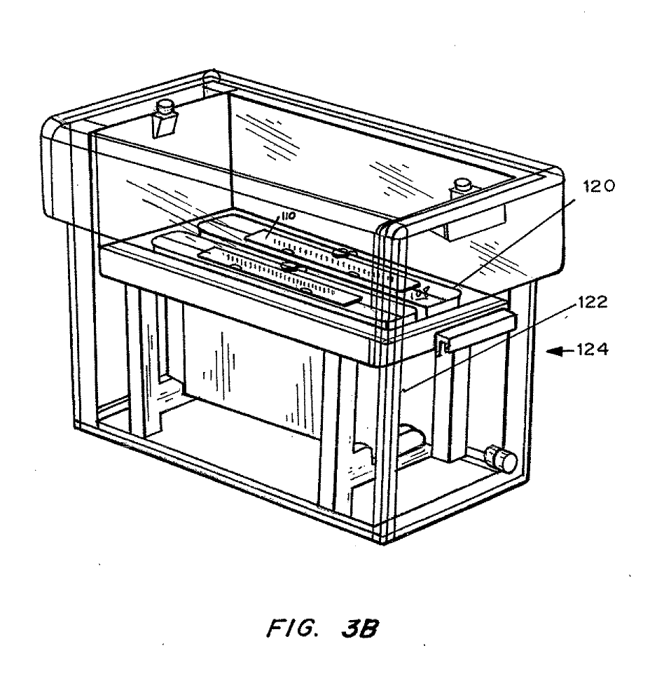

One embodiment provides a chip containing an array of protein traps positioned in a substrate. The protein traps (also referred to as “plugs”) in each have different or unequal pH ranges so that proteins with different pIs will be trapped in different plugs. Having plugs with many different pH ranges enables mixtures of multiple proteins to be fractionated into many different fractions. As shown in FIG. 3A, a representative chip 110 has 41 plugs ranging from pH 4.00 to pH 6.00. In each plug, the difference in pH between the two layers can be about 0.05 to 0.50 pH units, typically about 0.05 to about 0.10 pH units. Any number of plugs can be included on a chip 110. The chip 110 can be designed to have plugs with pH ranges so that every protein in a sample stops within the pH range of the chip. The chip 110 is placed between anode buffer chamber 114 and cathode buffer chamber 112 and inserted into the running buffer chamber shown in FIG. 3B. The chip 110 is removed after isoelectric trapping and placed in a second dimension running device of FIG. 3C.

Another embodiment provides plugs having at least one additional layer positioned between the trapping layer and the anode buffer. This layer is referred to as the “exit layer”. The exit layer has a pH greater than the trapping layer, usually above pH 7.0, for example about pH 8.0. The exit layer serves as an accelerator. Proteins having a pI less than the pH of the trapping layer will enter the exit layer and become more negatively charged. The increase in negative charge accelerates the movement of the protein into the anode chamber.

In another embodiment, the chip includes one or more transit plugs. Transit plugs have at least a single layer of a crosslinked matrix with immobilized pH buffers. The pH of transit plugs is acidic, for example less than pH 4.0, typically about pH 3.3 or less. Protein that enters the anode chamber can travel through the transit plug back to the cathode. Once the protein is returned to the cathode chamber, the protein will change its charge and travel through another plug until the protein becomes trapped in the plug with a pH range encompassing the pI of the protein.

In a computer simulation, two proteins, pI 5.16 and pI 5.04, now have distinct separations, with 80% collection. With a single layer region, there is spread, poor resolution, and only 35% collection.

Another embodiment provides plugs having different matrix formulations for the different layers. The formulation of the first layer can be heavier, and the next layer is lighter, and so on. The lighter layer floats on and does not mix with the heavier layer. Such formulations are known in the art. See for example P. G Righetti, Isoelectric focusing (Laboratory techniques in biochemistry and molecular biology) American Elsevier Pub. Co. (1976). The layers can be cast one after the other. Alternatively, a thin boundary layers can be set between pH layers, for example using sucrose or acrylamide mixed with glycerol. In another embodiment, a dispensing needle is filled upfront with all the layers which are dispensed in one stroke. This will create a smooth transition region between the layers.

B. Polyacrylamide Gels

The isoelectric focusing can be performed in cells of all forms and shapes, notably capillaries, slabs, and tubes. In capillaries the separation medium is most often the buffer solution itself, whereas in slab cells, tube cells and gel-filled capillaries, the separation medium is a gel equilibrated and saturated with the buffer solution.

Gel Substrates

Preferred materials to serve as a substrate for the gel include glass and plastics. The plastic materials used to form the support plates of the cassettes or dPC™ chip include a wide variety of plastics. The plastics are generally injection moldable plastics, and the selection is limited only by the need for the plastic to be inert to the gel-forming solution, the gel itself, the solutes (typically proteins) in the samples to be analyzed in the cassette, the buffering agents, and any other components that are typically present in the samples. Examples of these plastics are polycarbonate, polystyrene, acrylic polymers, styrene-acrylonitrile copolymer (SAN, NAS), BAREX® acrylonitrile polymers (Barex Resins, Naperville, Ill., USA), polyethylene terephthalate (PET), polyethylene terephthalate glycolate (PETG), and poly(ethylene naphthalenedicarboxylate) (PEN). Preferred plastics include polyvinylchloride, acrylics, acrylonitrile butadiene styrene (“ABS”), and styrene-acrylonitrile copolymers (“SAN”) but adhesion may be poor.

Monomer Solutions

Gels suitable for electrophoretic separation are described in U.S. Pat. No. 6,197,173 (Kirpatrick). The gel can be denaturing or non-denaturing. The gel can have various pore sizes. The gel can include additional components such as urea, detergent and a reducing agent as needed. See, e.g., Malloy, et al., Anal. Biochem. 280: pp. 1-10 (2000).

The gel typically is precast of polyacrylamide. The gel is usually cast between two sheets of glass or plastic. Various monomers can be used in addition to the conventional acrylamide/bis-acrylamide solution or agarose solutions to make a gel for use in the first and/or the second dimension. Hydroxyethylmethacrylate and other low-molecular weight acrylate-type compounds are commonly included as monomers. Polymers substituted with one or more acrylate-type groups have also been described in the literature (Zewert and Harrington, Electrophoresis 13: pp. 824-831, (1992)), as especially suitable for separations in mixed solvents of water with miscible organic solvents, such as alcohol or acetone. Gel-forming monomers can also be any substantially water-soluble molecule containing a photo-polymerizable reactive group, in combination with a material which can form cross-links, provided that the combination, once polymerized, forms a gel suitable for the particular type of electrophoresis.

Exemplary materials include acrylamide, in combination with methylene-bis-acrylamide or other known crosslinkers; hydroyethylmethacrylate and other low-molecular weight (less than about 300 daltons) derivatives of acrylic acid, methacrylic acid, and alkyl-substituted derivatives thereof such as crotonic acid; vinyl pyrrolidone and other low-molecular weight vinyl and allyl compounds; vinylic, allylic, acrylic and methacrylic derivatives of non-ionic polymers, including such derivatives of agarose (“Acrylaide” crosslinker, FMC Corp.), dextran, and other polysaccharides and derivatives, such as cellulose derivatives including hydroxyethyl cellulose; polyvinyl alcohol; monomeric, oligomeric and polymeric derivatives of glycols, including polymers of ethylene oxide, propylene oxide, butylene oxide, and copolymers thereof; acryl, vinyl or allyl derivatives of other water-compatible polymers, such as polyHEMA (polyhydroxyethyl acrylic acid), polymeric N-isopropyl acrylamide (which is temperature-sensitive), maleic-acid polymers and copolymers, partially hydrolysed EVAC (polymer of ethylene with vinyl acetate), ethyleneimine, polyaminoacids, polynucleotides, and copolymers of the subunits of these with each other and with more hydrophobic compounds such as pyridine, pyrrolidone, oxazolidine, styrene, and hydroxyacids. The polymerizable materials need not be entirely water-soluble, especially when solvents or surfactants are included in the gel-forming solution.

The gel-forming solution is an aqueous solution of a monomer mixture that is polymerizable, generally by a free-radical reaction, to form polyacrylamide. Monomer mixtures that have been used or are disclosed in the literature for use in forming polyacrylamide gels can be used. The monomer mixture typically includes acrylamide, a crosslinking agent, and a free radical initiator. Preferred crosslinking agents are bisacrylamides, and a particularly convenient crosslinking agent is N,N′-methylene-bisacrylamide. The gel-forming solution will also typically include a free radical initiator system. The most common system used is N,N,N′,N′-tetramethylenediamine (TEMED) in combination with ammonium persulfate. Other systems will be apparent to those skilled in the art.

Among those skilled in the use of electrophoresis and the preparation of electrophoresis gels, polyacrylamide gels are characterized by the parameters T and C, which are expressed as percents. The values of T and C can vary as they do in the use of polyacrylamide gels in general. A preferred range of T values is from about 5% to about 30%, and most preferably from about 10% to about 20%. A preferred range of C values of from about 1% to about 10% (corresponding to a range of weight ratio of acrylamide to bisacrylamide of from about 10:1 to about 100:1), and most preferably from about 2% to about 4% (corresponding to a range of weight ratio of acrylamide to bisacrylamide of from about 25:1 to about 50:1).

Methods for making polymerizable derivatives of common polymers are known in the art; for example, addition of allyl glycidyl ether to hydroxyl groups is known, as is esterification of hydroxyls with acids, anhydrides or acyl chlorides, such as acrylic anhydride. Amines are readily derivatized with acyl anhydrides or chlorides. Many of the derivatized polymers described above will contain more than one reactive group, and so are self-crosslinking. Addition of a crosslinking agent, which contains on average more than one reactive group per molecule, is required for formation of gels from monomers which have only one reactive group, such as acrylamide. These include, in addition to multiply-derivatized polymers, methylene bis-acrylamide, ethylene glycol diacrylate, and other small molecules with more than one ethylenically-unsaturated functionality, such as acryl, vinyl or allyl.

Candidate non-acrylamide monomers can include, e.g., allyl alcohol, HEMA (hydroxyethyl(meth)acrylate), polyethylene glycol monoacrylate, polyethylene glycol diacrylate, ethylene glycol monoacrylate, ethylene glycol diacrylate, vinylcaprolactam, vinylpyrrolidone, allylglycidyl dextran, allylglycidyl derivatives of polyvinylalcohol and of cellulose and derivatives, vinyl acetate, and other molecules containing one or more acryl, vinyl or allyl groups. Addition of linear polymers such as hydroxypropylmethylcellulose (HPMC) and HEMA to the monomer solution is used to increase gel strength.

Oxygen Scavengers; Adhesion Enhancing Agents

The interface irregularities of polyacrylamide gels that are precast in plastic gel cassettes can be reduced or eliminated by the inclusion of an oxygen scavenger in the gel-forming solution from which the gel is cast. The monomer mixture in the solution is polymerized with the scavenger present in the solution, and the result is a pre-cast gel with a substantially uniform pore size throughout. Band resolution in the cassette is then comparable to the band resolution that can be obtained with polyacrylamide gels in glass enclosures. Oxygen scavengers that can be used include many of the materials that have been used or disclosed for use as oxygen scavengers in such applications as boiler operations where they are included for purposes of reducing corrosion. Examples of these materials are sodium sulfite, sodium bisulfite, sodium thiosulfate, sodium lignosulfate, ammonium bisulfite, hydroquinone, diethylhydroxyethanol, diethylhydroxyl-amine, methylethylketoxime, ascorbic acid, erythorbic acid, and sodium erythorbate. Oxygen scavengers of particular interest include sodium sulfite, sodium bisulfite, sodium thiosulfate, sodium lignosulfate, and ammonium bisulfite. See, for example, U.S. Pat. No. 6,846,881 to Panattoni. In the most preferred embodiment, the oxygen scavenger is sodium pyrosulfite (Na₂O₅S₂).

These are not limited to isoelectric focusing gels, but are generally applicable to any polyacrylamide gel. Oxygen present in the air, dissolved in gel solution, and/or absorbed onto the surface of the substrate can inhibit, and in extreme cases, prevent acrylamide polymerization. Such inhibition can result in areas interface irregularities where polymerization is incomplete or has not occurred and thus there is no adhesion of the gel to the substrate. Further, oxygen on the surface of the substrate may prevent the polymer as it forms from adhering to the surface.

The amount of oxygen scavenger included in the gel-forming solution can be varied over a wide range. Certain plastics will require a greater amount of oxygen scavenger than others since the amount of oxygen retained in the plastic varies among different plastics and the manner in which they are formed. The optimal amount of oxygen scavenger may also vary with the choice of scavenger. In general, however, best results will be obtained with a concentration of oxygen scavenger that is within the range of from about 1 mM to about 30 mM, and preferably from about 3 mM to about 15 mM, in the aqueous gel-forming solution. The amount of oxygen scavenger used may also affect the optimal amounts of the other components. For example, certain oxygen scavengers display catalytic activity toward the free radical reaction, and a lower concentration of free radical initiator can then be used when such scavengers are present. When a sulfite or bisulfite is used, for example, the concentrations of TEMED and ammonium persulfate (or other free radical initiator system) can be lower than would otherwise be used.

C. Buffers

IEF Buffers

An IEF buffer includes components that have a buffering capacity around a given pH value (buffering agent) or components that organize to form a pH gradient (e.g., ampholytes, immobilines or a combination of buffering agents). The IEF buffer is in the form of a liquid, slurry or a gel such that a biomolecule can pass through IEF buffer unless the pI of the biomolecule is in the pH range of the IEF buffer. An IEF buffer can include other components such as urea, detergent and a reducing agent as needed. See, e.g., Malloy, et al., Anal. Biochem. 280: pp. 1-10 (2000). It is desirable that the IEF buffers are functionally stable under the influence of an electric field.

IEF buffer or cell including the IEF buffer can be formed by hand or by various devices. For example, the IEF buffer can be deposited (e.g., coated, printed or spotted) on the surface of a substrate or in a groove or channel of a substrate. The substrate can be a matrix as described below or a bead made of the same material as the matrix. The IEF buffer can be made by a device that mixes an acidic and basic solution to form a buffer having the desired pH value (“titrator”). The buffer is combined with a monomer (e.g., acrylamide) and polymerizing agent and loaded into another device (“matrix printer”) that lays the IEF buffer in a desired position on the matrix. These devices can be incorporated into an automated system.

Ampholines are a set of various oligo-amino and/or oligocarboxylic acids that are amphoteric (i.e., positively charged in acidic media and negatively charged in basic media), soluble and have Mᵣ values from approximately 300 up to 1000. Ampholytes can be prepared or purchased. For example, several carrier ampholytes are known in the art (e.g., pages 31-50, Righetti, P. G., (1983) Isoelectric Focusing: Theory, Methodology and Applications, eds., T. S. Work and R. H. Burdon, Elsevier Science Publishers B. V., Amsterdam; U.S. Pat. No. 3,485,736). Alternatively, purchased ampholytes include Ampholines (LKB), Servalyts® (Serva), Biolytes or Pharmalytes™ (Amersham Pharmacia Biotech, Uppsala, Sweden).

Immobilines are non-amphoteric, bifunctional acrylamido derivatives of the general formula: CH₂═Ch—CO—NH—R. Immobilines can be prepared or purchased. For example, methods for synthesizing immobilines are known in the art (Bjellquist et al., (1983) J. Biochem. Biophys. Methods, 6:317). The immobilines can be copolymerized with the acrylamide to form IPG's (immobilized pH gradients). IPG's can be prepared by methods known in the art or can be purchased.

pH gradients can be formed by mixing amphoteric or non-amphoteric buffers. For example, such buffers and combinations are described in Allen, R C et al., Gel Electrophoresis and Isoelectric focusing of Proteins: Selected Techniques, Berlin: Walter de Gruyter & Co. (1984); and in U.S. Pat. No. 5,447,612 (Bier). IEF buffering agents include 50 mM glycine, 14 mM NaOH; 50 mM HEPES, 12 mM NaOH; 50 mM THMA, 44.6 mM HCl; 52 mM citrate acid, 96 mM Na₂HPO₄; 50 mM BICINE, 18 mM NaOH; and 50 mM DMGA, 40 mM NaOH. The pH gradient created by the IEF buffer in each cell can have a narrow or a wide pH range (e.g., pH 6.8-pH 7.8 or pH 6.8-pH 12.8, respectively).

An IEF buffer can have an extremely narrow pH range, e.g. 5.50-5.60 (0.1 pH unit or less difference) or ultra narrow pH range, e.g., 5.52-5.54 (0.02 pH unit difference or less). This is possible because an IEF buffer can be one buffering agent that has been adjusted to a certain pH value. In this case, the pH range of the IEF buffer is equivalent to the buffering capacity of the buffering agent around the pH value to which the buffering agent had been adjusted. The term “interval” refers to the incremental difference in a pH value within the pH gradient created by the IEF buffer. The term “step” refers to the incremental difference in pH value between two different IEF buffers. For example, within one cell, the intervals can be as small as 0.02 pH units through the full pH range in that cell (e.g., pH 6.8, pH 7.0, pH 7.2, etc., in that cell). In another example, the pH “step” between an IEF buffer in cell #1 and cell #2 can be 0.1 pH unit. For example, the IEF buffer in cell #1 can have a pH gradient starting at pH 6.8 and ending at pH 7.8 and the IEF buffer in cell #2 can have a pH gradient starting at pH 7.9 and ending at pH 8.9 (i.e., pH 7.9 minus pH 7.8). The term “pH range” refers to the highest to the lowest pH values in an IEF buffer or a cell including an IEF buffer (e.g., pH 7.9-pH 8.9), or the difference between the highest and lowest pH values in an IEF buffer or a cell including an JEF buffer (e.g., 1.0 pH units). The intervals within a cell do not have to be uniform or sequential. Further, the pH steps between two cells of a plurality of cells do not have to be uniform.

Exemplary classes of buffers including:

(1) Buffering agents with a small number of charged groups per molecule, and preferably of a relatively high molecular weight. The buffering agents may consist of a single species or a combination of two or more species, to provide both acidic and basic buffering groups. In the case of a mixture of two or more species, the molecular weight ranges cited above refer to the molecular weights which are weight-averaged between the species, as well as within any single species which has an inherent molecular weight range. An example of a buffering agent with a molecular weight below 2,000 is a mixture TAPS with pKa of 8.44 and 2-amino-2-methyl-1,3-propanediol with pK of 8.8. Examples of buffering agents with molecular weights of about 2,000 and above are derivatized polyoxyethylenes with one to three, and preferably two, charged buffering groups per molecule. The derivatized polyoxyethylenes may be used in combinations, such as for example one containing two basic buffering groups per molecule and a second containing two acidic buffering groups per molecule. One example of such a combination is a mixture of polyoxyethylene bis(3-amino-2-hydroxypropyl) and polyoxyethylene bis(acetic acid) with pK values of approximately 9 and 5, respectively.

(2) Carrier ampholytes fractionated to a narrow pH range by isoelectric focusing. Carrier ampholytes are well known among biochemists who use electrophoresis, and are widely used for isoelectric focusing. The term “carrier ampholyte” refers to a complex mixture of molecules which vary in their isoelectric points. The isoelectric points span a range of values, with a sufficient number of different isoelectric points among the molecules in the mixture to produce essentially a continuum of values of the isoelectric points. The buffers must be amphoteric, have decent buffering capacities and are able to carry a current. Thus, when a cell or vessel such as a flat plate sandwich, a tube, or a capillary is filled with a solution of a carrier ampholyte and a voltage is applied across the solution with an acid as the anolyte and a base as the catholyte, the individual ampholyte molecules arrange themselves in order of increasing isoelectric point along the direction of the voltage.

Carrier ampholytes can be formed from synthetic substances or from naturally occurring materials. A variety of synthetic carrier ampholytes are available for purchase to laboratories. Examples are the PHARMALYTES® of Pharmacia LKB, Uppsala, Sweden, and the BIO-LYTES® of Bio-Rad Laboratories, Inc., Hercules, Calif., U.S.A. Examples of carrier ampholytes derived from naturally occurring substances are hydrolyzed proteins of various kinds. BIO-LYTES® are polyethyleneimines derivatized with acrylic acid, with molecular weights of about 200 or greater. The variation in isoelectric point results from the large number of isomeric forms of the starting polyethyleneimine, and the range is achieved in a single derivatization reaction.

The carrier ampholyte is isoelectrically focused and a fraction at a selected pH is isolated and recovered. The fractionation and recovery are readily performed by preparative isoelectric focusing techniques using laboratory equipment designed for this purpose. An example of a preparative isoelectric focusing cell is the ROTOFOR® Cell manufactured by Bio-Rad Laboratories. To achieve the best results, the fractionation is preferably performed in such a manner as to achieve as narrow a pH range as conveniently possible. In preferred embodiments, the pH range of the fraction is at most about 0.2 pH units in range, and in the most preferred embodiments, about 0.1 pH units in range. The midpoint of the pH range in these preferred embodiments is from about pH 3 to about pH 10, and most preferably from about pH 5 to about pH 9.

(3) Low molecular weight buffering ampholytes at their isoelectric points, the isoelectric point being one which is close in value to one of the pK values of the ampholyte. These ampholytes are relatively low molecular weight compounds, preferably with molecular weights of about 500 or less, with buffering groups in free form rather than neutralized to salt form. An ampholyte is dissolved in deionized, carbon-dioxide-free water, and the pH of the resulting solution is very close to the isoelectric point of the ampholyte. The conductivity of the solution is therefore very low. Ampholytes meeting this description which also have a pK value that is approximately equal to the isoelectric point have a substantial buffering capacity sufficient for use as a running buffer for electrophoresis.

These ampholytes preferably have three or more pK values, at least one of which is within about 1.0 of the isoelectric point of the ampholyte. These values can be spaced apart by up to 7 or 8 pK units, or two or more of them can be very close in value. Examples of ampholytes meeting these descriptions are lysine, aspartyl-aspartic acid, glycyl-L-histidine, glycyl-aspartic acid, hydroxylysine, glycyl-glycyl-L-histidine, N-cyclohexyl-iminodiacetic acid, N-(1-carboxycyclohexyD-iminodiacetic acid, and cyclobutane-1,2-bis(N-iminodiacetic acid).

(4) High molecular weight buffering ampholytes in which the acidic and basic groups have the same or very close pK values. Preferred ampholytes of this type are derivatized polymers having molecular weights of about 2,500 or greater. Polyoxyethylene glycols are examples of polymers which can be used effectively for this purpose. Derivatization can be achieved for example by conjugating the polymer to boric acid or a boric acid derivative at one end and an amino derivative at the other. An example of a boric acid derivative is 3-(aminophenyl) boronic acid; examples of amino derivatives are 2-amino-2-methyl-1,3-propanediol and 2-amino-2-methyl-1-propanol. Substantially equal pK values for the acid and basic groups can be achieved by synthesizing the compound in a manner which will provide the boric acid residue with a pK value which is somewhat higher than that of the amino group residue, then adjusting the pH to the pK value of the amino group by the addition of sorbitol.

Running Buffers

Electrophoresis can be performed in running buffers of low electrical conductivity and yet achieve high resolution. With low conductivity buffers, electrophoresis can be performed at high field strengths while experiencing less of the difficulties encountered with conventional buffers. Low conductivity buffers permit one to increase the field strength well beyond levels typically used for capillary electrophoresis without a loss in resolution. Buffer solutions are characterized at least in part by conductivity low enough to permit the use of voltages well in excess of the typical voltages used for capillary electrophoresis, without substantial loss in peak resolution. While the conductivity can vary depending on how fast a separation is desired and therefore how high a voltage is needed, best results in most cases will be obtained with conductivities in the range of 25×10⁻⁵ ohm⁻¹ cm⁻¹ or less. In preferred embodiments, the conductivities are within the range of about 1×10⁻⁵ ohm⁻¹ cm⁻¹ to about 20×10⁻⁵ ohm⁻¹ cm⁻¹, and in particularly preferred embodiments, the conductivities are within the range of about 2×10⁻⁵ ohm⁻¹ cm⁻¹ to about 10×10⁻⁵ ohm⁻¹ cm⁻¹. Typical voltages for slab gel range are about 300 volts per cm (along the distance of the direction of the voltage). For capillaries, where the voltages used are generally higher than other forms, voltages are in the range of about 600-750 volts, up to about 2000 volts, per cm of capillary length or greater. See also U.S. Pat. No. 5,464,517 to Hjertén et al.

### II. Secondary Separation Gels

Complex mixtures can be further separated. A very common practice after isoelectric separations is to further separate the analytes according to their molecular weight. Many techniques are utilized in the art to accomplish this. As an illustrative example, the gel device from the first dimension is equilibrated with an ionic surfactant, such as sodium dodecylsulfate (SDS), to impart a uniform charge density to the analytes. These analyte-surfactant complexes are separated according to their molecular weight by observing their electrophoretic migration through a restrictive slab gel. It is usual in conventional isoelectric focusing for the transfer to be to a slab polyacrylamide gel. In the case of the dPC device, the second dimension can be a slab, if the pH features are arranged in a linear array, or alternatively it can be a multiplicity of columns arranged in a pattern that assures intimate contact with each pH feature of the dPC. The advantage of the dPC arrangement is that features of known pH are held in one-to-one correspondence with locations on the second dimension analysis.

In the most common execution of a two dimensional electrophoretic analysis, the second dimension consists of a molecular weight based separation. To accomplish this, analytes separated in the first dimension are complexed with a surfactant, such as sodium dodecylsulfate, that imparts a uniform particle charge density. The protein analyte-surfactant complexes are formed by passive diffusion, or by electrophoretic movement of the surfactant into the first dimension analytical gel. It is advantageous to have an extended stacking gel region that mitigates any inconsistencies in the transfer rate of protein analytes. Any stacking gel, as is known in the art, can be used for this purpose, such as, but not limited to, a low percentage polyacrylamide (less than about 6%) or agarose (less than about 3%). The stacking gel must be greater than 0.5 mm thick and is preferably between 1 and 30 mm.

Other types of devices may be used in the second dimension, including capillary electrophoresis, liquid chromatography, membrane transfer, Western blotting or direct mass spectroscopy device where the first dimension is a matrix and the second dimension or mass spectroscopy is positioned so that the plugs all line up.

For rapid sample screening, the dPC™ can be run in a conventional SDS-PAGE format, as shown in FIG. 3C. Since the dPC™ gel plugs are in a rigid plastic frame, it is easy to transfer and align the dPC™ on a slab gel. The 2D gel image after dPC™ fractionation differs from conventional 2D electrophoresis because the pI information is presented from discrete pH gel zones.

To further assure uniformity of contact and analyte transfer between the first and second dimensions, it is advantageous to provide a conductive fluid medium that is non-restrictive to analyte flow, and that serves to fill any gaps between the first and second dimensions. Second dimension running buffers are known in the art. In one embodiment, the stacking gel is cast in place and in contact between the first and second dimensions. Alternatively, a flowable gel, such as, but not limited to, linear polyacrylamide, methyl cellulose, hydroxypropyl methyl cellulose, ethyl cellulose, cellulose ether, xanthan, uncharged polysaccharides, or polyols, or mixtures thereof, can be utilized. The gel must have a low enough apparent viscosity for easy application, but a high enough viscosity so that the gel does not flow out of place within the timescale of the second dimension analysis.

Any of the contact media used between the first and second dimensions may also contain additive components that assist in the electrophoretic migration of the analytes, such as buffers, and/or dyes, such as bromophenol blue, that aid in the visualization of the electrophoresis progress.

### III. IEF-Secondary Separation System

First dimension, pI-based separations are a common practice in the analysis of complex protein mixtures. To accomplish this, in general, soluble proteins are forced to migrate in an electric field in the presence of a pH gradient. The protein analytes attain an apparent positive charge at pH values below their pI, and will migrate toward the cathode, while the opposite is true at pH values above their pI. The pH gradient is arranged such that the lowest pH values are toward the anode end of the device, and the highest pH values are toward the cathode. Proteins stop migrating when they reach the pH where their electrophoretic mobility reaches zero, i.e., their pI. Proteins can be analyzed in either native or denatured states, using substances like urea or thiourea or other commonly used denaturants. The pH gradients are commonly established via the pH ordering of a mixture of amphoteric buffers, known in the art as carrier ampholytes, in an electric field, or by the copolymerization of a gradient of acid and base moieties within the structure of a polyacrylamide gel, known as immobilized pH gradients (IPG).

U.S. Pat. No. 7,166,202 to Zilberstein and Bukshpan disclose a discrete pH trapping device, referred to as the digital proteome chip, or dPC™. In the dPC™, an array containing a multiplicity of discrete pH features serves as a permeable partition between an acidic anode buffer chamber and a basic cathode buffer chamber. Proteins below their pI in the anode chamber exhibit a net positive charge and migrate toward the cathode through the pH features that maintain the protein below its pI. Conversely, proteins above their pI in the cathode chamber exhibit a net negative charge, and migrate toward the anode through the pH features that maintain the protein above its pI. Proteins tend to accumulate in the pH features closest to their pI, where their net migration is either zero at the pI, or very slow near the pI. The advantage of the dPC™ is that by its discrete nature the pH of any specific feature is known according to its formulation, rather than by being extrapolated from known endpoints, as is done in the carrier ampholyte or IPG systems. A characteristic of the dPC™ system is that the electrophoretic migration of the analytes is not serial to the pH gradient, but random.

Protein Forest's digital ProteomeChip™ (dPC™), fractionates complex protein mixtures according to their isoelectric points. The dPC™ handles sample volumes up to 1500 μL, containing up to 2.2 mg protein. The entire separation process can be completed in 30 minutes. Sample is added directly to the running buffer so there is no need for rehydration step. Resolution of the fraction is very high since the pH buffers are less than 0.1 pH units apart. The discrete pH features guarantee pI information. The system is also compatible with all sample types including neat proteins or protein mixes, human cell lysates, bacterial cell lysates, tissue lysates, plasma, and serum. As a result, the dPC™ provides researchers with a fast, easy-to-use, and reproducible tool to enhance their samples prior to complex analyses, such as intact mass, amino acid sequencing, immunoblotting, size separation or tryptic digestion mass spec. For example, separating 60 μg of an E. coli cell lysate plus 135 ng hGH, yields 8% (13 ng) in a single plug, 15-20% of the protein trapped in the pI plugs, 15-20% in the cathode buffer and 30-40% in the anode buffer.

FIG. 3B depicts a transfer device 120 to a vertically run slab gel. The transfer device has the capability of locating a first dimension analytical gel, such as the dPC 110, and a mechanism by which the first dimension is firmly held in place. In FIG. 3B, the dPC 110 is located by placing it in a recessed location on the transfer collar 108. In a typical utilization of the device depicted in FIG. 3B, a second dimension cassette 122 containing a molecular weight separating slab gel is positioned against the upper stops of the transfer device 10 and clamped in place. The second dimension 122 is cast with an extended stacking gel zone as described above, or with a gap so that a stacking gel may be cast in situ.

The first dimension analytical gel 11 is placed in the positioning device so that it is in electrical communication with the opening of the second dimension slab gel 122 via the liquid, i.e., there is complete contact between the dpc 110 and the second dimension gel 122 through either the flowable contacting medium or the stacking gel cast in situ. The transfer device is designed with a minimum of extraneous openings, so that during the second dimension electrophoretic separation the electric field passes substantially through the first dimension analytical gel, and not around it. The assembly of the first dimension analytical gel, transfer collar and second dimension slab is run in a manner known in the art in a suitable electrophoresis tank 124 shown in FIG. 3C.

For rapid sample screening, the dPC™ can be run in a conventional SDS-PAGE format. Since the dPC™ gel plugs are in a rigid plastic frame, it is easy to transfer and align the dPC™ on a slab gel.

Fractionated proteins can be transferred to a liquid phase in Protein Forest's dPC™ MicroEluter. The electroeluter is in the same array format as the dPC™, so that the entire dPC™ can be processed at once. The receiving chambers, approximately 10 μL, recover proteins in a liquid phase without unnecessary dilution. Rapid fractionation can occur in 30 minutes or less. This reduces analysis time by 80%. The sample is added directly to the running buffer, so there is no need for rehydration step.

The present invention will be further understood by reference to the following non-limiting examples.

### EXAMPLE 1

### Comparison of Recovery Using 0.1 Step pI Trap to No Trap.0

dPC™ manufacture. A glass blank with forty one 1 mm×2 mm holes was treated with silane to ensure glass to polymer adhesion. An array of pIs was created by mixing acrylamido buffers between a range of pH 4.2 and 6.2 at a 0.1 pH step. The range pH 4.2-6.2 is repeated twice in the chip. The final concentration of the immobiline buffers are between 12-30 mM, 6% C, 8% T. Using a robotic dispenser, 2.2 ul of the acrylamido buffer solution was dispensed into each hole followed by 8 minutes UV photopolymerization with a methylene blue/DPIC/STS system. 20 plugs ranging from 4.20, 4.30, 4.40 to 6.20 were into the first 20 plugs and then repeated for the next 20 plugs. To create a two pH layered chip, 0.2 ul of acrylamido buffer pk 3.6 was added to one side of the gel plug followed by an additional 22 minutes photopolymerization. No additional acrylamido buffer was added to the single layer plugs. After polymerization, the chip was washed, stored at neutral pH in 20% glycerol.

dPC™ running. The sample is pretreated as follows. 20 μl/30 μg of E. coli cell lysate is reduced by TBP and alkylated with iodoacetamide then stored in 50 mM Na Phosphate buffer pH 7.4. The sample is then added to 20 μl of denaturing buffer (7M urea, 2M thiourea, 1.8% CHAPS, 1% TRITON X-100 40 mM DTT) and incubated for 10 minutes. The sample is added to the cathode chamber with 710 μl additional denaturing buffer containing 0.25% Pharmalytes 5-8. The anode buffer is 750 μl denaturing buffer and 0.25% Pharmalytes 2.5-5. The voltage ramp is 0-300 volts over 6 minutes, followed by additional 24 minutes running time. Temperature is maintained at 10° C. through cooling blocks and the entire system is gently mixed by reciprocal shaking.

dPC™ SDS PAGE. The dPC chip is pre-incubated for 10 minutes in SDS buffer and coupled via the collar to a second dimension 4-20% gel SDS PAGE, The second dimension is run using a Laemmli buffer system, 35-100 mA per gel, on conventional equipment. The gel is stained overnight in a SYPRO ruby stain according manufactures instructions.

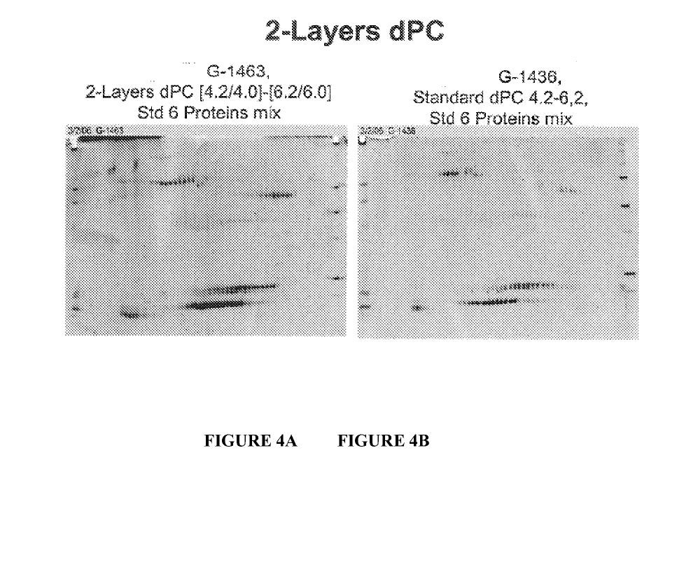

As demonstrated by FIGS. 4A and 4B, the trap doubles the amount of sample separated, compared to the same gel in the absence of the trap.

### EXAMPLE 2

### Comparison of Recovery Using Pharmalytes in the Running Buffers

dPC manufacture: dPC chips were manufactured as in Example 1 except no second pH layer was applied, the pH range was pH 4.2-6.2 and the step was 0.05 pH. The sample was pretreated and run as Example 1 with or without 0.25% Pharmalytes pH 2.5-5 in the anode and 0.25% Pharmalytes pH 5-8 in the cathode. dPC separated proteins were transferred to a second dimension gel as described earlier and Sypro Ruby stained.

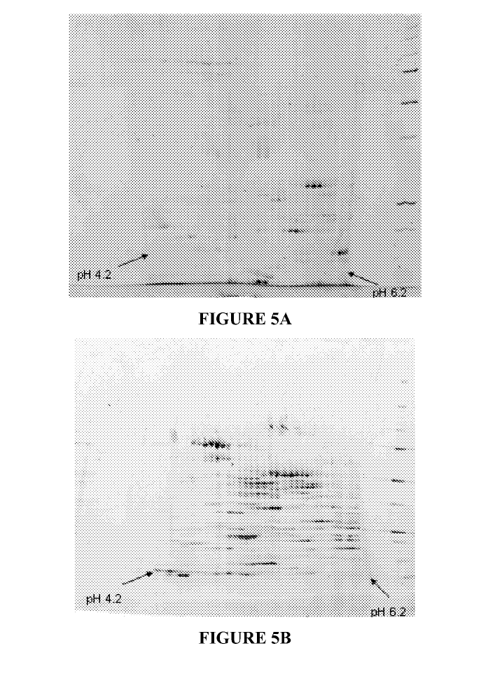

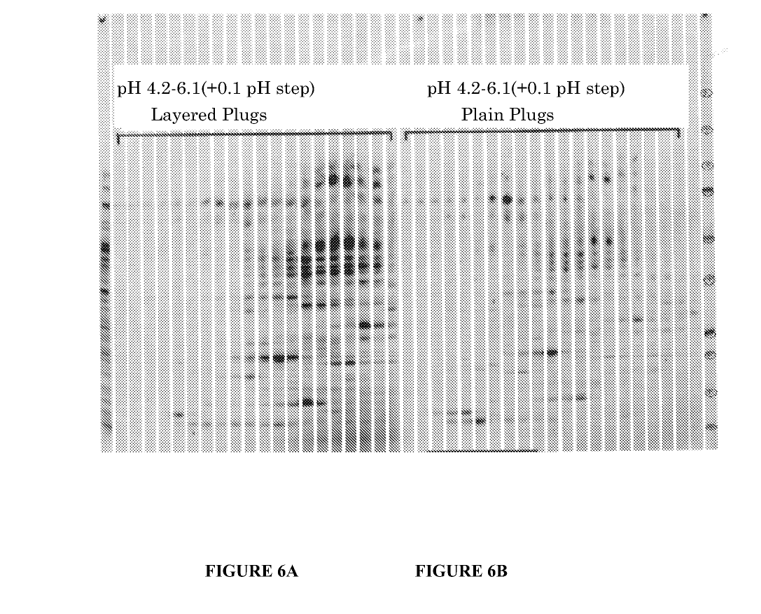

FIGS. 5A and 5B are photographs comparing proteome coverage of an E. coli lysate separation between pH 4.2 and 6.2 by dPC™ isoelectric focusing and SDS PAGE 4-20% gels second dimension. FIG. 6A is the separation of E. coli lysate without pharmalytes and DTT in running buffers. FIG. 6B shows the separation of E. coli lysate with 0.25% pharmalytes and 40 mM DTT in running buffers. The comparison clearly shows higher protein yield and resolution through the addition of Pharmalytes to the running buffers.

### EXAMPLE 3

### Comparison of Recovery Using 0.1 step pI Traps to No Trap; with Ampholyte Added to Buffer

dPC manufactured and run as in Example 1. The sample was reduced and alkylated [¹²⁵I]-ovalbumin spiked into 30 μg E. coli lysate. After isoelectric trapping, the individual gel plugs were extruded from the glass chip, placed in 100 μl SOLVABLE™ Packard Instruments and stored overnight at ambient temperature. 10 μl was added to 300 ul ULTIMAGOLD™ liquid scintillation cocktail prior to radioactive counting. [¹²⁵I]-ovalbumin isoelectric.

As shown by FIGS. 6A and 6B, trapping collection increased by 70% with the pI 0.1 step traps.

### EXAMPLE 4

### Comparison of Currents During Running with Reducing Agents

dPC was manufactured and run as in Example 1. The sample run was reduced and alkylated E. coli lysate 30 ug. The running buffers were as described in Example 1 except the addition of reducing agents. The concentration of reducing agent and measured current (mA) were: 0 reducing agent, 3.9 mA; 4 mM DTT, 3.68 mA; 40 mM DTT, 2.46 mA and 80 mM beta mercaptoethanol, 2.08 mA. The addition of reducing agent, also improved the collection efficiency and resolution.

Variations and modifications of the present invention will be obvious to those skilled in the art and are intended to come within the scope of the appended claims. All references cited herein are specifically incorporated by reference

We claim:

1. An isoelectric focusing gel trap forming a part of or suitable for application to an electrophoresis gel matrix, the trap comprising
a first layer comprising immobilized pH buffers and having a first pH, and
a second layer comprising immobilized pH buffers and having a second, different pH,
wherein the trap is suitable for application of sample to the first layer.

2. The trap of claim 1 further comprising a neutral gel layer between the first and second layer.

3. The trap of claim 1, wherein the neutral gel layer comprise trehalose, glycerol, sucrose, or a combination thereof.

4. The trap of claim 1 wherein the difference in pH between the layers is about 0.1 to about 0.05 pH units or less.

5. The trap of claim 1 wherein the pH range in the second layer is between 0.2 and 0.1 units different than the range in the first layer.

6. The trap of claim 1 in an isoelectric focusing gel.

7. The trap of claim 1, in an array comprising two or more traps.

8. The array of claim 7 comprising traps ranging in pH from 4.0 to about 6.0, wherein the first and second layers of each trap differ in pH by about 0.1 to about 0.05 pH units.

9. A method of improving resolution or yield in an isoelectric focusing gel comprising providing in the gel an isoelectric focusing gel trap forming a part of or suitable for application to an electrophoresis gel matrix,
the trap comprising
a first layer comprising immobilized pH buffers and having a first pH, and
a second layer comprising immobilized pH buffers and having a second, lower pH,
wherein the trap is suitable for application of sample to the first layer.

10. The method of claim 9 comprising forming a barrier layer in the middle of a hole in an isoelectric focusing gel, then forming a layer on one side of the barrier comprising ampholytes with a first pH, then forming a layer on the other side of the barrier comprising ampholytes with a second pH, wherein the layers are formed by polymerization of an acrylamide monomer solution.

11. A method for isolating a molecule in a sample comprising
subjecting the sample to an electrical field that is directed through an isoelectric focusing gel trap forming a part of or suitable for application to an electrophoresis gel matrix, the trap comprising
a first layer comprising immobilized pH buffers and having a first pH, and a second layer comprising immobilized pH buffers and having a second, different pH,
wherein the trap is suitable for application of sample to the first layer,
until the molecule becomes trapped in the isoelectric focusing trap of if the molecule has an isoelectric point less than the pH of the first layer and greater than the pH of the second layer.

12. A method of gel electrophoresis comprising providing in the running buffer a reducing agent.

13. The method of claim 12 wherein the reducing agent is selected from the group of thiol compounds consisting of dithiothreitol, beta-mercaptoethanol, methanethiol, dithioerythritol, cysteine, glutathione, allyl mercaptan, and 2-mercaptoindole.

14. The method of claim 13 wherein the reducing agent is added in the amount of 1 to 100 mM.

15. The method of claim 12 wherein the gel electrophoresis is isoelectric focusing.

16. A method of isoelectric focusing comprising providing in the running buffer ampholytes or linear polyacrylamides in a concentration of between 0.1-1%.

17. The method of claim 16 wherein the ampholytes or linear polyacrylamides are added in the range of 0.25-0.5% to the sample running buffers.

18. The method of claim 16 further comprising added a reducing agent to the running buffer in an amount of 1 to 100 mM.

19. A running buffer for use in the method of claim 12.

20. The running buffer of claim 19, wherein the reducing agent is selected from the group of thiol compounds consisting of dithiothreitol, beta-mercaptoethanol, methanethiol, dithioerythritol, cysteine, glutathione, allyl mercaptan, and 2-mercaptoindole.

21. The running buffer of claim 20, wherein the reducing agent is present in an amount between 1 to 100 mM.

22. The running buffer of claim 19, wherein the gel electrophoresis is isoelectric focusing.

23. A running buffer for use in the method of claim 16.

24. The running buffer of claim 23, wherein the ampholytes or linear polyacrylamides are present in the range of 0.25-0.5%.

25. The running buffer of claim 23 further comprising a reducing agent in an amount between 1 to 100 mM.
